(19) United States
(12) Patent Application Publication
(10) Pub. No.: US 2014/0355296 A1
(43) Pub. Date: Dec. 4, 2014

(54) LINEAR LIGHT SOURCE APPARATUS FOR AN IMAGE READER

(71) Applicant: USHIO DENKI KABUSHIKI KAISHA, Tokyo (JP)

(72) Inventor: Minoru Shigoku, Hyogo (JP)

(73) Assignee: USHIO DENKI KABUSHIKI KAISHA, Tokyo (JP)

(21) Appl. No.: 14/290,074

(22) Filed: May 29, 2014

(30) Foreign Application Priority Data
May 29, 2013 (JP) 2013-112939

(51) Int. Cl. F21V 8/00

(52) U.S. Cl. CPC G02B 6/0096
USPC 362/558

(57) ABSTRACT

A linear light source apparatus for an image reader that has an effective light emitting length substantially equal to or longer than the length of the light conductor. The apparatus includes a rod-shaped light conductor, a light emitting element, a concave reflection mirror, and a diffusing-and-reflecting member that has a diffusing-and-reflecting plane disposed to face a reflecting portion of the light conductor along the longitudinal direction. The diffusing-and-reflecting member has a facing portion facing the light emitting element. The facing portion is provided at the end of the diffusing-and-reflecting plane of the diffusing-and-reflecting member in the vicinity of the light emitting element. Light from the light emitting element and/or the concave reflection mirror is incident on the light emitting element facing portion. That light is reflected toward the end face of the light conductor in the vicinity of the light emitting element, and introduced into the light conductor.

### FIELD OF THE INVENTION

The present invention generally relates to a linear light source apparatus for an image reader, and more particularly to a linear light source apparatus that may be used as an illumination light source of an image reader used for, in particular, a facsimile machine, a copying machine, an image scanner, a barcode reader or the like.

### DESCRIPTION OF THE RELATED ART

Conventionally, a copying machine or a similar apparatus is equipped with an image reader, and the image reader has a light permeable object placement table, on which an object to be read is placed. The image reader irradiates the object to be read, such as a document (script document or original copy), placed on the light permeable object placement table with light. Light reflecting from the object to be read is used to read character and/or image information on the target surface of the object to be read. The image reader also has a light source apparatus for the image reader to irradiate the target surface of the object to be read with the light through the light permeable object placement table.

One kind of light source apparatus for an image reader is shown in FIGS. 11 and 12 of the accompanying drawings. As illustrated in these drawings, the light source apparatus is located below an object placement table 5 (FIG. 11), on which an object to be read is placed, and includes a linear light source (i.e., linear light emitting unit 61 shown in FIG. 12), and a planar reflection mirror 67 (FIG. 11) arranged next to the linear light emitting unit 61. This linear light source apparatus for the image reader is called a bifurcation type (two-branch type, split type), and disclosed in, for example, Japanese Patent Application Laid-Open Publication No. 2011-249190.

In this linear light source apparatus for the image reader, the linear light emitting unit 61 includes a rod-shaped light conductor (light guiding element) 20, which is made of a light permeable material. The light conductor 20 has two reflecting portions (i.e., first reflecting portion 23A and a second reflecting portion 23B) extending in the longitudinal direction of the light conductor 20 on the outer circumferential surface of the light conductor 20. The light conductor 20 also has a light irradiating surface 22 that extends in the longitudinal direction of the light conductor 20 on its outer circumferential surface. The linear light emitting unit 61 also includes two light emitting elements 12 arranged to face the two opposite end faces 21 of the light conductor 20, respectively. The linear light emitting unit 61 is configured to convert spot-like light emitted from the light emitting elements 12 into linear light through the light conductor 20.

The linear light emitting unit 61 has two concave reflection mirrors 63 arranged to surround the two light emitting elements 12 respectively, and a light conductor support member (support stand) 65 for supporting the light conductor 20. In the linear light emitting unit 61, the light conductor support member 65 has a diffusing-and-reflecting (diffused reflection) plane (surface) 65A that faces other regions of the outer circumferential surface of the light conductor 20 than the light irradiating surface 22. The diffusing-and-reflecting plane 65A extends in the longitudinal direction of the light conductor 20. The light conductor support member 65 serves as a support stand to precisely hold the light conductor 20, and as a diffusing-and-reflecting member to cause the light leaking from the light conductor 20 to diffuse and reflect at the diffusing-and-reflecting plane 65A and then return to the light conductor 20. By returning the leaking light to the light conductor, effective use of the light is achieved. Each concave reflection mirror 63 has a concave reflection surface 64 that defines, for example, a cylindrical space or a circular truncated cone space. The concave reflection mirror 63 also has a light projecting opening 63A that is slightly smaller, in diameter, than the end face 21 of the light conductor 20. The light projecting opening 63A is closed by the end face 21 of the light conductor 20. The concave reflection mirror 63 is configured to efficiently collect the light from the associated light emitting element 12 at the concave reflection surface 64, and introduce (guide) the light to the light conductor 20.

In the light source apparatus for the image reader that has the above-described structure, the light from the linear light emitting unit 61 is directly irradiated onto the object to be read (e.g., document 2 in the illustrated example) on the object placement surface (document table surface) 5A of the object placement table 5, and also indirectly irradiated onto the object to be read after being reflected by the planar reflection mirror 67. Because the object to be read is irradiated with the light from the two directions, it is possible to accurately read characters and image information even if the object to be read is not two-dimensional but three-dimensional.

In the illustrated example (FIG. 11), the optical path L1 indicates the optical path of the light from the first reflecting portion 23A (i.e., reflected light or reflection light) among the light emitted from the light irradiating surface 22, and the optical path L2 indicates the optical path of the light from the second reflecting portion 23B (i.e., another reflected light or reflection light) among the light emitted from the light irradiating surface 22. The optical path L3 (FIG. 12) indicates the optical path of the light that transmits the reflecting portion (the first reflecting portion 23A in FIG. 12) and is reflected (diffused and reflected) by the diffusing-and-reflecting plane 65A, among the light emitted from the light irradiating surface 22.

When the image reader is equipped with the above-described linear light source apparatus for the image reader, the length of the object to be read which can be read by the reading apparatus, i.e., the effective light emitting length of the linear light source apparatus for the image reader, depends upon the length (total length) of the light conductor 20 and is shorter than the length of the light conductor 20. This is because the effective light emitting length of the linear light source apparatus for the image reader is decided by the effective light emitting length given by the linear light emitting unit 61 in the main (primary) scanning direction and also because the light (reflected light) from the reflecting portion (i.e., first reflecting portion 23A and second reflecting portion 23B) of the light conductor 20 possesses directivity in a direction substantially (generally) perpendicular to the longitudinal direction of the light conductor 20. Specifically, most of the light emitted from the light irradiating surface 22 of the light conductor 20 is the light from the reflecting portions so that the light from the light conductor 20 has the directivity in a direction substantially perpendicular to the longitudinal direction of the light conductor 20. Thus, that area of the object placement table surface 5A, which corresponds to the center area of the light conductor 20 in the longitudinal direction of the light conductor 20, is irradiated with the light from the center area of the light conductor 20 and the light from the both neighboring areas of the center area in the longitudinal direction of the light conductor 20. The former light and the latter light are superimposed on the area of the object placement table 5A which corresponds to the center area of the light conductor 20.

On the other hand, each of those areas of the object placement table surface 5A, which corresponds to one of end areas of the light conductor 20 in the longitudinal direction (i.e., longitudinal end areas of the light conductor 20) is irradiated with the light from one of the longitudinal end areas of the light conductor 20 and the light from the neighboring area of one side of the longitudinal end area of the light conductor 20. The former light and the latter light are only superimposed on the area of the object placement table surface 5A which correspond to one of the longitudinal end areas of the light conductor 20. As a result, quantity of light irradiated (received) at the object placement table surface 5A is smaller in those areas either one of which correspond to the longitudinal end areas of the light conductor 20, respectively, than in that area which corresponds to the center area of the light conductor 20. Therefore, the effective light emitting length of the linear light source apparatus for the image reader becomes shorter than the length of the light conductor 20.

In this specification, the expression “effective light emitting length of the linear light source apparatus for the image reader” means a length of a region that has substantially the same illuminance as the reference illuminance (e.g., at least 80% of the reference illuminance). The reference illuminance is taken as 100%. The reference illuminance is an illuminance on the object placement table surface 5A which corresponds to the center area in the longitudinal direction of the light conductor 20.

In recent years, there is a demand for downsizing to the linear light source apparatus for the image reader, nevertheless the demand for the size of the object to be read does not change. Thus, the length of the light conductor cannot be reduced, and the downsizing of the light source device is not yet achieved.

### SUMMARY OF THE INVENTION

The present invention is proposed in view of the above-described facts, and an object of the present invention is to provide a linear light source apparatus for an image reader that has an effective light emitting length substantially equal to or longer than the length of the light conductor.

According to one aspect of the present invention, there is provided a novel linear light source apparatus for an image reader. The linear light source apparatus includes a rod-shaped light conductor, which is made of a light permeable material. The light conductor has a reflecting portion extending in the longitudinal direction of the light conductor on the outer circumferential surface of the light conductor. The linear light source apparatus also includes a light emitting element arranged to face an end face of the light conductor. The linear light source apparatus also includes a concave reflection mirror arranged to surround the light emitting element. The linear light source apparatus also includes a diffusing-and-reflecting member that has a diffusing-and-reflecting plane disposed to face the reflecting portion along the longitudinal direction of the light conductor.

A facing portion for the light emitting element, which faces the light emitting element, (referred to as “light emitting element facing portion”) is provided at the end of the diffusing-and-reflecting plane of the diffusing-and-reflecting member in the vicinity of the light emitting element. Light from the light emitting element and/or the concave reflection mirror is incident on the light emitting element facing portion. The light incident (irradiated) on the light emitting element facing portion is reflected toward the end face of the light conductor in the vicinity of the light emitting element, and introduced (guided) into the light conductor.

In the linear light source apparatus for the image reader according to the present invention, the light projecting opening of the concave reflection mirror may be preferably provided to be exposed to the end face of the light conductor and the light emitting element facing portion.

In the linear light source apparatus for the image reader according to the present invention, a reflection mirror may be preferably provided to face the light conductor along the longitudinal direction of the light conductor.

Preferably, the reflecting portion of the light conductor may have a first reflecting portion and a second reflecting portion. The first and second reflecting portions may extend in the longitudinal direction of the light conductor, and the first reflecting portion may be spaced from the second reflecting portion. Preferably, a first light irradiating section may be formed in a region opposite the first reflecting portion on the outer circumferential surface, and a second light irradiating section may be formed in a region opposite the second reflecting portion on the outer circumferential surface.

Preferably, light from the first reflecting portion may be emitted toward an object placement surface, on which the object to be read is placed, from the first light irradiating section, and light from the second reflecting portion may be emitted toward the reflection mirror from the second light irradiating section, such that the light from the reflection mirror and the light from the first reflecting portion are superimposed each other on the object placement surface.

In the linear light source apparatus for the image reader having the above-described configuration according to the present invention, the reflection mirror preferably may have a main (primary) reflection plane (reflecting surface portion) that faces the light conductor and the object placement surface, and an auxiliary (supplementary, secondary) reflection plane (reflecting surface portion) that reflects light directed outward of the longitudinal end of the light conductor from the main reflection plane, toward the main reflection plane.

In the linear light source apparatus for the image reader according to the present invention, the facing portion for the light emitting element is disposed at the end of the diffusing-and-reflecting plane of the diffusing-and-reflecting member in the vicinity of the light emitting element, and the light from the light emitting element and/or the concave reflection mirror is incident on the facing portion for the light emitting element. The light incident on the facing portion for the light emitting element is reflected toward the adjacent end face of the light conductor by the facing portion for the light emitting element and introduced into the interior of the light conductor. The light is then emitted from the light irradiating surface. The light from the facing portion for the light emitting element (i.e., reflected light) has the directivity in a direction inclined toward the light emitting element that faces the facing portion for the light emitting element. Because of such configuration, even if the optical component of the light from the reflecting portion (reflected light) has the directivity in a direction generally (substantially) perpendicular to the longitudinal direction of the light conductor, the light from the facing portion for the light emitting element (reflected light) supplements (adds) an optical component that has the directivity in a direction inclined toward the light emitting element, and therefore the light irradiating direction of the light emitted from the light irradiating surface of the light conductor is adjusted. As a result, a band-shaped irradiation region which extends greatly in the longitudinal direction of the light conductor is formed. Thus, it is possible to obtain an effective light emitting length which is substantially the same as or more than the length of the light conductor.

Consequently, when the light source apparatus for the image reader according to the present invention is employed, the length of the light conductor can be reduced without reducing the effective light emitting length, and the entire apparatus (or image reader) size can be reduced. As such, it is possible to provide a compact linear light source apparatus for an image reader that has a long effective light emitting length.

These and other objects, aspects and advantages of the present invention will become apparent to those skilled in the art from the following detailed description when read and understood in conjunction with the appended claims and drawings.

### BRIEF DESCRIPTION OF THE DRAWINGS

FIG. 1 illustrates a plan view which is useful to explain a configuration of an exemplary linear light source apparatus for an image reader according to one embodiment of the present invention;

FIG. 2 is a cross-sectional view of the linear light source apparatus for an image reader shown in FIG. 1, taken along the line 2-2, with the linear light source apparatus being mounted on the image reader;

FIG. 3 is a cross-sectional view of a linear light emitting unit of the linear light source apparatus for an image reader shown in FIG. 1, taken in the longitudinal direction thereof;

FIG. 4 is a cross-sectional view of the linear light emitting unit shown in FIG. 3, taken along the line 4-4, with the linear light source apparatus being mounted on the image reader;

FIG. 5 is a cross-sectional view of the linear light emitting unit shown in FIG. 4, taken along the line 5-5;

FIG. 6 is a cross-sectional view which shows a configuration of another exemplary linear light source apparatus for an image reader according to the present invention;

FIG. 7 is a cross-sectional view which shows a configuration of still another exemplary linear light source apparatus for an image reader according to the present invention;

FIG. 8 is a cross-sectional view which shows a configuration of yet another exemplary linear light source apparatus for an image reader according to the present invention;

FIG. 9 is a cross-sectional view which shows a configuration of another exemplary linear light source apparatus for an image reader according to the present invention;

FIG. 10 illustrates a graph showing illuminance distribution curves which are obtained from an experimental example I of the invention and a comparative example I;

FIG. 11 is a cross-sectional view of a conventional linear light emitting unit for an image reader, with the linear light source apparatus being mounted on the image reader; and

FIG. 12 is a cross-sectional view of a linear light emitting unit of the linear light source apparatus for an image reader shown in FIG. 11, taken in the longitudinal direction thereof.

### DETAILED DESCRIPTION OF THE INVENTION

A preferred embodiment of the present invention will now be described with reference to the drawings.

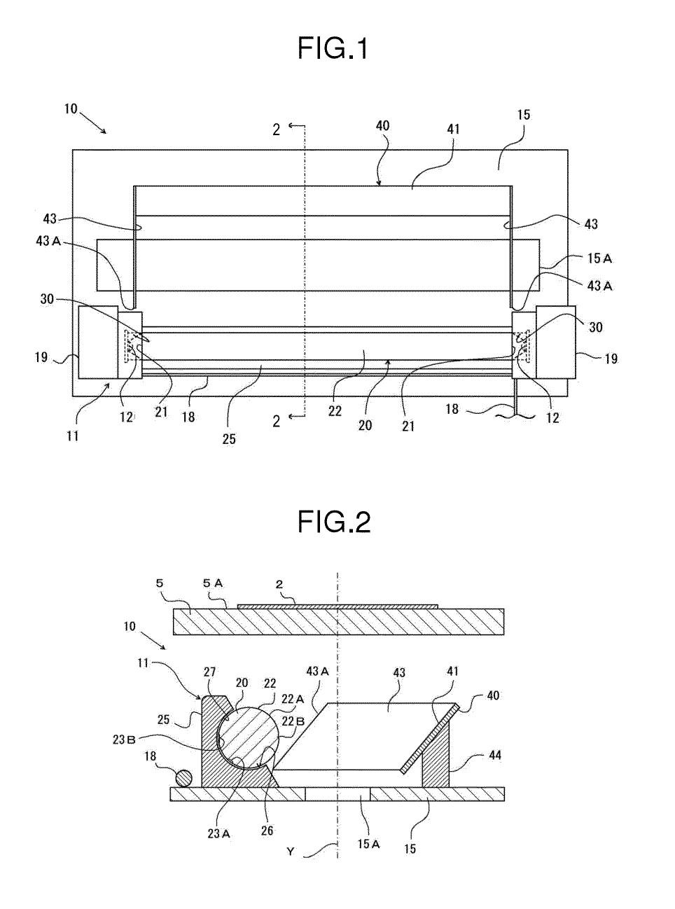

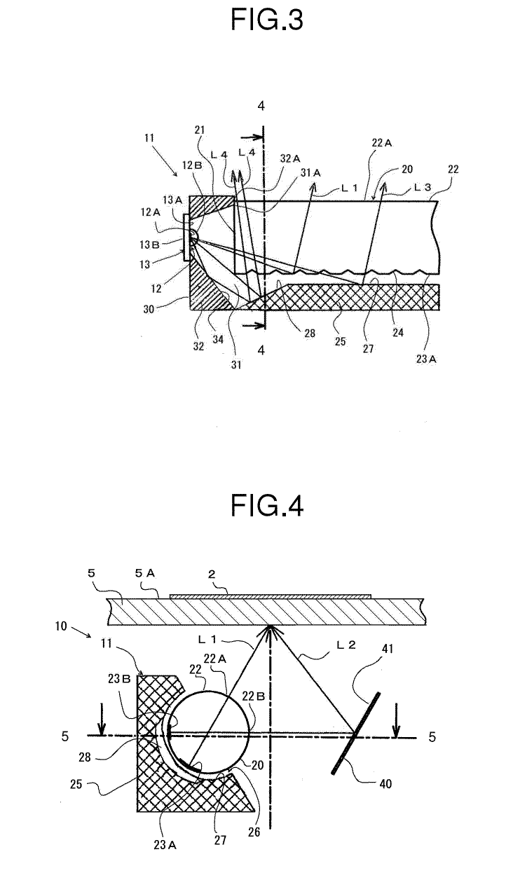

FIG. 1 is a plan view which is useful to explain a configuration of an exemplary linear light source apparatus 10 for an image reader according to an embodiment of the present invention. FIG. 2 is a cross-sectional view of the linear light source apparatus 10 for an image reader shown in FIG. 1, taken along the line 2-2, with the linear light source apparatus 10 being mounted on the image reader. FIG. 3 is a cross-sectional view of a linear light emitting unit 11 of the linear light source apparatus 10 for an image reader shown in FIG. 1, taken in the longitudinal direction thereof. FIG. 4 is a cross-sectional view of the linear light emitting unit 11 shown in FIG. 3, taken along the line B-B, with the linear light source apparatus 10 being mounted on the image reader. FIG. 5 is a cross-sectional view of the linear light emitting unit 11 shown in FIG. 4, taken along the line C-C.

The linear light source apparatus 10 for an image reader includes a linear light source constituted by the linear light emitting unit 11. The linear light emitting unit 11 has a rod-shaped light conductor 20. The light conductor 20 is made from a light permeable material. The linear light emitting unit 11 also has light emitting elements 12 and 12 disposed to spacedly face opposite end faces 21 and 21 of the light conductor 20, respectively. The linear light emitting unit 11 also has concave reflection mirrors 30 and 30 disposed to surround the light emitting elements 12 and 12, respectively. The linear light source apparatus 10 also includes an elongated planar (or plate-shaped) reflection mirror 40 along the linear light emitting unit 11. The planar reflection mirror 40 is arranged such that the planar reflection mirror 40 is spaced from the light conductor 20 and extends in parallel to the light conductor 20. In other words, the planar reflection mirror 40 extends along the light conductor 20 in the longitudinal direction of the light conductor 20 and faces the light conductor 20 with a predetermined distance.

The linear light emitting unit 11 has a light conductor support member 25 to support the light conductor 20. The light conductor support member 25 is an elongated member, and extends in the same direction as the light conductor 20. The light conductor support member 25 fixedly supports the light conductor 20 such that a light irradiating surface 22 of the light conductor 20 is directed in a predetermined direction.

The planar reflection mirror 40 is fixedly supported by a planar reflection mirror support member 44 such that a planar reflecting plane 41 is directed in a predetermined direction. The planar reflection mirror support member 44 is an elongated member, and arranged to be generally parallel to the light conductor support member 25 with a predetermined distance.

In this linear light source apparatus 10 for an image reader, the light conductor support member 25 and the planar reflection mirror support member 44 are provided on a common base 15. The common base 15 is a rectangular plate-shaped (planar) member.

In the illustrated embodiment, wirings 18 and 18 are disposed on the common base 15 to supply the light emitting elements 12 and 12 with electricity. Heat sinks 19 and 19 are provided over the concave reflection mirrors 30 and 30 to release the heat generated from the associated light emitting elements 12, respectively.

As shown in FIG. 2, the linear light source apparatus 10 for an image reader is placed below an object placement table 5 of the image reader, on which an object to be read is to be placed, when the linear light source apparatus 10 is mounted on (or in) the image reader. The object placement table 5 is light permeable, and the object to be read such as a document (script document or original copy) 2 is placed on an object placement surface (document table surface) 5A. The light conductor 20 extends along a flat plane which is parallel to the object placement table surface 5A in the main scanning direction. The light conductor 20 and the planar reflection mirror 40 are generally symmetrically arranged with respect to an object reading axis Y such that the object reading axis Y, which is perpendicular to the object placement table surface 5A, is positioned at an approximate center between the light conductor 20 and the planar reflection mirror 40.

In this specification, the “secondary (or auxiliary) scanning direction” is a moving direction of the linear light source apparatus 10 when the linear light source apparatus 10 is relatively moved in parallel to the object placement table surface 5A and in a direction perpendicular to the longitudinal direction of the light conductor 20. The “main (or primary) scanning direction” is a moving direction of the linear light source apparatus 10 when the linear light source apparatus 10 is moved in a direction perpendicular to the secondary scanning direction and in parallel to the object placement table surface 5A.

The common base 15 is made from a metallic material such as aluminum or iron. The common base 15 is a planar member and shaped like a rectangular frame having a rectangular slit 15A. The slit 15A allows the light reflected by the document 2 to be transmitted between the light conductor support member 25 and the planar reflection mirror support member 44. The slit 15A of the common base 15 extends in the same direction as the light conductor 20 and the planar reflection mirror 40. Because the slit 15A is formed in the common base 15 in the above-described manner, the light reflecting from the document 2 is received at, for example, a CCD (not shown) arranged below the light source apparatus 10.

As shown in FIGS. 3 and 5, each of the two light emitting elements 12 and 12 has, for example, a blue LED (light emitting diode) element 12A, and the blue LED element 12A is sealed by a sealing element 12B that contains a yellow fluorescent substance (phosphor). Each light emitting element 12 converts blue light emitted from the associated blue LED element 12A through the yellow fluorescent substance to emit white light.

In the illustrated embodiment, the blue LED element 12A of each light emitting element 12 is sealed by the hemispherical sealing element 12B, and each light emitting element 12 is mounted on one surface (right surface) 13A of a base plate 13. The other (opposite) surface 13B of the base plate 13 is entirely in contact with the heat sink 19.

The light conductor 20 is a rod-shaped element which has a generally cylindrical shape. The light conductor 20 has the light irradiating surface 22 along the longitudinal direction of the light conductor 20 in that region on its outer circumference which faces the object placement table 5 and the planar reflection mirror 40.

The light conductor 20 also has a first reflecting portion 23A and a second reflecting portion 23B on a part of the outer circumference of the light conductor 20, which arranged opposite the light irradiating surface 22 of the light conductor 20. The first reflecting portion 23A is spaced from the second reflecting portion 23B. The first reflecting portion 23A and the second reflecting portion 23B may be collectively referred to as “the reflecting portion of the light conductor” or “the light conductor reflecting portion.” Each of the first reflecting portion 23A and the second reflecting portion 23B extends perpendicularly to the two end faces 21 and 21 of the light conductor 20, and spans the two end faces 21 in the longitudinal direction of the light conductor 20. The first reflecting portion 23A is formed to face the object placement table 5 through the light irradiating surface 22, and the second reflecting portion 23B is formed to face the planar reflection mirror 40 through the light irradiating surface 22.

The light irradiating surface 22 has a first light irradiating section 22A in a region that faces the first reflecting portion 23A, and a second light irradiating section 22B in a region that faces the second reflecting portion 23B.

In the illustrated embodiment, one or more protruding portions for positioning (not shown) are provided on the outer circumferential surface of the light conductor 20 in those areas in which the light conductor reflecting portion is absent. The protruding portions protrude from the outer circumferential surface of the light conductor 20, and extend in the longitudinal direction of the light conductor 20. One or more groups (sets) of micro-prisms are formed on the surface of the reflecting portion of the light conductor 20 (i.e., the first reflecting portion 23A and the second reflecting portion 23B). As shown in FIGS. 3 and 5, the groups of micro-prisms are defined by a plurality of groove-like concave portions 24 that are formed side by side in the longitudinal direction of the light conductor 20.

In the illustrated embodiment, each of the groove-like concave portions 24 grooves in the radial direction of the light conductor 20, and its cross-section has a V shape when viewed in the longitudinal direction of the light conductor 20. The neighboring groove-like concave portions 24 are spaced from each other.

The light permeable material of the light conductor 20 may be a light permeable resin such as acrylic resin, polycarbonate resin, cycloolefin copolymer (COC), cycloolefin polymer (COP).

The longitudinal length of the light conductor support member 25 is substantially the same as the entire length of the light conductor 20. The light conductor support member 25 functions as a supporting member for the light conductor 20 and also as a diffusing-and-reflecting member. Specifically, the light conductor support member 25 has a light conductor supporting portion, and the light conductor supporting portion has a light conductor facing surface 27 that extends in the longitudinal direction of the light conductor 20. The light conductor facing surface 27 faces the outer circumferential surface of the light conductor 20 except for the light irradiating surface 22. The longitudinal length of the light conductor facing surface 27 is equal (or substantially equal) to the length of the light conductor 20, and the light conductor facing surface 27 faces the light conductor reflecting portion (the first reflecting portion 23A and the second reflecting portion 23B) along the longitudinal direction of the light conductor 20. The light conductor facing surface 27 is to be used as a diffusing-and-reflecting plane.

In the embodiment depicted in FIGS. 1-5, the light conductor support member 25 has a generally trapezoidal pillar shape when viewed from the outside. One side face among the four side faces of the light conductor support member 25 has a light conductor supporting section, which is constituted by a groove 26 extending in the longitudinal direction of the light conductor support member 25. The groove 26 that defines the light conductor supporting section has a generally semicircular shape when viewed in a cross-section in a direction perpendicular to the longitudinal direction of the groove 26. The inner wall of the groove 26 forms the light conductor facing surface 27. The light conductor facing surface 27 faces the outer circumference of the light conductor 20, excluding the light irradiating surface 22, with a small clearance (gap).

The light conductor facing surface 27 also has a concave portion for positioning (not shown) that extends in the longitudinal direction of the light conductor 20. The concave portion for the positioning protrudes from the light conductor facing surface 27 and is formed in a region that faces the light conductor 20 except for the reflecting portion of the light conductor 20. This concave portion for the positioning has a shape that fits the convex (protruding) portion for the positioning of the light conductor 20. As the protruding portion for the positioning of the light conductor 20 is fitted in the concave portion for the positioning of the light conductor support member 25, the light conductor 20 is fixed in a desired (predetermined) condition or posture, i.e., the outer circumference of the light conductor 20, except for the light irradiating surface 22, faces the light conductor facing surface 27 of the light conductor support member 25 with a small gap.

Light emitting element facing portions 28 and 28 are formed at the ends of the light conductor facing surface 27 of the light conductor support member 25 such that the light emitting element facing portions 28 and 28 are present in the vicinity of the light emitting elements 12 and 12 and face the light emitting elements 12 and 12, respectively. The light emitting element facing portions 28 and 28 are formed in regions that face the reflecting portion of the light conductor 20.

In the illustrated embodiment, each of the light emitting element facing portions 28 and 28 is provided at the end in the vicinity of the associated light emitting element 12 and extends to face the first reflecting portion 23A, the gap between the first and second reflecting portions 23A and 23B on the outer circumference of the light conductor 20, and the second reflecting portion 23B, as shown in FIG. 4.

Each of the two light emitting element facing portions 28 and 28 is directed outwards such that each light emitting element facing portion 28 is irradiated with (receives) the light from the associated light emitting element 12 and/or the light from the concave reflection mirror 30 and such that the light emitting element facing portion 28 reflects this incident light toward the end face 21 of the light conductor 20 in the vicinity of the light emitting element facing portion 28 concerned, and introduces the light into the light conductor 20. Specifically, each light emitting element facing portion 28 is directed outwards as the light emitting element facing portion 28 is inclined (tapered) towards the outside of the longitudinal edge of the light conductor facing surface 27 from the inside to the outside of the light conductor facing surface 27 in the longitudinal direction of the light conductor facing surface 27.

In the illustrated embodiment, each of the light emitting element facing portions 28 and 28 is defined by the flat and smooth tapered plane inclined such that the light emitting element facing portion 28 is gradually spaced from the light conductor 20 from the inside to the outside in the longitudinal direction of the light conductor facing surface 27.

Each light emitting element facing portion 28 is arranged to face the associated light emitting element 12 and spacedly face the reflecting portion of the light conductor 20 to cause the light from the associated light emitting element 12 and/or the light from the associated concave reflection mirror 30 to directly enter the light conductor 20.

In the illustrated embodiment, the distance between the tapered surface of each light emitting element facing portion 28 and the light conductor 20 becomes greater as the distance measuring position on the light emitting element facing portion 28 shifts to the outside from the inside in the longitudinal direction of the light conductor facing surface 27.

The maximum distance between the light emitting element facing portion 28 and the light conductor 20 may be 0.6 mm, and the minimum distance may be 0.2 mm. The distance between the light conductor facing surface 27, excluding the light emitting element facing portions 28 and 28, and the light conductor 20 may be 0.2 mm and constant.

The length of each light emitting element facing portion 28 in the longitudinal direction of the light conductor 20 is appropriately decided, depending upon the effective light emitting length needed to the linear light source apparatus 10 for the image reader, the length of the light conductor 20 and other factors while the distance between the end face 21 of the light conductor 20 and the associated light emitting element 12, the cross-sectional shape of the light conductor 20 (the cross-sectional shape taken in a direction perpendicular to the longitudinal direction), the shape of the concave reflection mirror 30 (specifically, the shape of the concave reflection surface 34) and other factors are taken into account.

In the illustrated embodiment, the length of the light conductor facing surface 27 in the longitudinal direction may be 320 mm. Each of the light emitting element facing portions 28 and 28 may extend 10 mm from the longitudinal edge of the light conductor facing surface 27.

The material of the light conductor support member 25 may be a white resin which is obtained by whitening, for example, the polycarbonate resin.

Each of the two concave reflection mirrors 30 and 30 has a cylindrical base member 32, and a concave reflection surface 34 is formed on the inner circumference of the cylindrical base member 32. One opening (first opening) of the base member 32 defines the light projecting opening 31.

Each concave reflection mirror 30 surrounds the associated light emitting element 12 and also surrounds, in combination with the light emitting element 12, the space between the end face 21 of the light conductor 20 and the light emitting element 12 (may be referred to as “reflection mirror inner space”). The light projecting opening 31 of the concave reflection mirror 30 is exposed to the end face 21 of the light conductor 20 and the light emitting element facing portion 28.

Specifically, the light projecting opening 31 of each concave reflection mirror 30 (one opening of the base member 32) is exposed to the end face 21 of the light conductor 20 and the light emitting facing portion 28, and the reflection mirror inner space communicates with the clearance (gap) between the light conductor reflecting portion and the light emitting element facing portion 28. The other opening (second opening) of the base member 32 has a diameter equal to or smaller than the diameter of the above-mentioned “one opening (first opening)” of the base member 32, and is greater than the diameter of the light emitting element 12. The diameter of the second opening of the base member 32 has a size that can be closed by one face 13A of the base plate 13, on which the light emitting element 12 is to be mounted.

With such configuration, the concave reflection mirror 30 can efficiently collect the light from the light emitting element 12 and guide the light to the light conductor 20. It is also possible to cause the light from the light emitting element 12 and/or the light from the concave reflection mirror 30 to enter the light emitting element facing portion 28.

In the illustrated embodiment, each concave reflection mirror 30 has a cylindrical shape in its appearance, and possesses the base member 32 that has a generally cylindrical shape with a through hole of a generally truncated cone shape being formed. The first generally circular opening of the base member 32 having a larger diameter defines the light projecting opening 31. The second circular opening of the base member 32 having a smaller diameter is closed by the face 13A of the base plate 13, on which the light emitting element 12 is mounted. The first opening of the base member 32 (light projecting opening 31) confronts the end face 21 of the light conductor 20 and the light emitting element facing portion 28. The end face 32A of the base member 32, which forms the first opening of the base member 32, seals (closes) the space between the peripheral edge of the end face 21 of the light conductor 20 and the light conductor facing surface 27 except for the light emitting element facing portion 28 at the longitudinal edge. Therefore, the opening periphery 31A of the light projecting opening 31 of the concave reflection mirror 30 is located outwardly apart from the peripheral edge of the end face 21 of the light conductor 20 (i.e., spaced from the end face 21 of the light conductor 20) in a region where the peripheral edge of the end face 21 of the light conductor 20 faces the light emitting element facing portion 28. In other regions, the opening periphery 31A of the light projecting opening 31 of the concave reflection mirror 30 is located inward of the peripheral edge of the end face 21 of the light conductor 20 (i.e., located on the peripheral edge of the end face 21 of the light conductor 20). That portion of the opening periphery 31A of the light projecting opening 31, which is present outside the peripheral edge of the end face 21 of the light conductor 20, is joined to the longitudinal edge of the light conductor facing surface 27 (longitudinal edge of the light emitting element facing portion 28).

The material of the base member 32 may be, for example, a metal such as aluminum or an alloy such as stainless. When the metal or the alloy is used as the material of the base member 32, the inner circumference of the base member 32 may be mirror finished to provide the concave reflecting surface 34.

Alternatively, the material of the base member 32 may be a white resin which is obtained by whitening (bleaching), for example, a polycarbonate resin or a polyethylene terephthalate resin.

The planar reflection mirror 40 has a main reflecting surface section, which is constituted by the planar reflecting surface 41 and faces the light conductor 20 and the object placement table surface 5A. The planar reflecting surface 41 faces the second reflecting portion 23B through the second light irradiating portion 22B of the light conductor 20.

The planar reflecting surface 41 has an elongated rectangular shape, and the longitudinal length of the planar reflecting surface 41 is equal to or greater than the length of the light conductor 20.

In the illustrated embodiment, the planar reflection mirror 40 is fixedly supported by a reflection mirror support member 44 such that the planar reflection mirror 40 is inclined 60 degrees relative to the object placement table surface 5A of the image reader.

The longitudinal length of the planar reflecting plate (reflection plate) 41 is slightly greater than the length of the light conductor 20.

The planar reflection mirror 40 has two auxiliary (secondary) reflecting surface portions to reflect the light, which is directed outward of the longitudinal ends of the main reflecting surface portion of the light conductor 20 (i.e., the light which is directed outward of the longitudinal ends of the planar reflecting surface 41) toward the main reflecting surface portion.

Specifically, as shown in FIG. 5, each of the auxiliary reflecting surface portions can reflect the light (the light along the optical path L4 in FIG. 5), which is directed outward of the longitudinal end of the planar reflecting surface 41 among the light emitted from the second light irradiating portion 22B, to the planar reflecting surface 41.

The auxiliary reflecting surface portions include planar reflecting surfaces 43 and 43 disposed at longitudinal ends of the planar reflecting surface 41 of the main reflecting surface portion. The planar reflecting surfaces 43 and 43 extend perpendicularly to the planar reflecting surface 41 and toward the light conductor 20. The two planar reflecting surfaces 43 and 43 face each other and are parallel to each other.

In the illustrated embodiment, each of the planar reflecting surfaces 43 and 43 of the auxiliary reflecting portions has an elongated parallelogram shape, and the longitudinal edge 43A of each planar reflecting surface 43 is present in the vicinity of the concave reflection mirror 30. The planar reflecting surfaces 43 and 43 are arranged to enclose (surround) the space between the light conductor 20 and the planar reflecting surface 41.

The material of the planar reflection mirror support member 44 may be a metal such as aluminum or a resin such as polycarbonate resin.

In the illustrated embodiment, the longitudinal length of the planar reflection mirror support member 44 is the same as or close to the longitudinal length of the planar reflecting surface 41 of the planar reflection mirror 40.

In the linear light source apparatus 10 for the image reader having the above-described configuration, the light from each of the light emitting elements 12 and 12 is directly incident onto the opposing (associated) end face 21 of the light conductor 20 and is reflected by the associated concave reflection mirror 30 to be guided and incident onto the opposing (associated) end face 21 of the light conductor 20. The light incident onto the end faces 21 and 21 of the light conductor 20 is guided in the longitudinal direction of the light conductor 20 by the light conductor 20, and is incident onto the first reflecting portion 23A and the second reflecting portion 23B, respectively. Most of such light is reflected by the first reflecting portion 23A or the second reflecting portion 23B, and the reflected light is emitted from the light irradiating surface 22 of the light conductor (see the optical paths L1 and L2 in FIGS. 3 and 4). On the other hand, part of the light incident onto the reflecting portion of the light conductor 20, i.e., the light that transmits the light conductor 20 through the first reflecting portion 23A or the second reflecting portion 23B, is reflected by the light conductor facing surface 27 (diffusing-and-reflecting plane) of the light conductor support member 25, and the reflected light is introduced into the light conductor 20. The light which is forced to return to the interior of the light conductor 20 by the light conductor facing surface 27 is emitted from the light irradiating surface 22 of the light conductor 20 together with the light reflected by the first reflecting portion 23A and the second reflecting portion 23B (see the optical path L3 in FIG. 3).

As such, in the linear light source apparatus 10 for the image reader, the light emitting element facing portions 28 and 28 are provided on the light conductor facing surface 27, and the light from the light emitting elements 12 and 12 and/or the concave reflection mirrors 30 and 30 is directly incident onto the light emitting element facing portions 28 and 28, respectively. The light incident onto the light emitting element facing portion 28 is reflected toward the adjacent end face 21 of the light conductor 20 by the light emitting element facing portion 28, and the reflected light (the light along the optical path L4) is introduced into the light conductor 20 and emitted from the light irradiating surface 22. The reflected light of the light emitting element facing portion 28 has the directivity in a direction inclined toward the opposing (associated) light emitting element 12. Thus, even if the optical component of the reflection light of the light conductor reflecting portion possesses the directivity in a direction generally perpendicular (normal) to the longitudinal direction of the light conductor 20, the reflection light of the light emitting element facing portions 28 and 28 supplements the optical component that possesses the directivity in a direction inclined toward the light emitting elements 12 and 12, which oppose (confront) the light emitting element facing portions 28 and 28. Therefore, the light irradiating direction of the light emitted from the light irradiating surface 22 of the light conductor 20 can be appropriately adjusted. As a result, a belt-like (band-shaped) irradiation region is formed, which greatly elongates in the longitudinal direction of the light conductor 20. That area of the object placement table surface 5A, which corresponds to the center area of the light conductor 20 in its longitudinal direction, is irradiated with the light from the center area of the light conductor 20 and the light from the adjacent areas, on both sides in the longitudinal direction, of the center area of the light conductor 20. The light from the center area of the light conductor 20 and the light from the adjacent areas of the center area of the light conductor 20 are superimposed on the object placement table surface 5A.

On the other hand, each of those areas of the object placement table surface 5A, each of which corresponds to the longitudinal end area of the light conductor 20, is irradiated with the light from the longitudinal end of the light conductor 20, the light from the area adjacent to one side of the longitudinal end of the light conductor 20 and the light from the light emitting element facing portions 28 and 28. Such light from the light from the longitudinal end of the light conductor 20, the light from the area adjacent to one side of the longitudinal end of the light conductor 20 and the light from the light emitting element facing portions 28 and 28 are superimposed on the object placement table surface 5A. In this manner, those areas of the object placement table surface 5A, which correspond to the longitudinal end areas of the light conductor 20, are given substantially the same quantity of the light as the center area of the light conductor 20. It is therefore possible to obtain the effective light emitting length that is substantially equal to or greater than the length of the light conductor 20.

As such, the linear light source apparatus 10 for the image reader according to the present embodiment can reduce the length of the light conductor 20 without entailing a drawback of reduced effective light emitting length, and can achieve the downsizing of the linear light source apparatus (or the image reader equipped with the linear light source apparatus).

The linear light source apparatus 10 for the image reader also includes the planar reflection mirror 40, and the light conductor 20 has the second reflecting portion 23B and the second light irradiating portion 22B. Thus, among the light emitted from the light irradiating surface 22 of the light conductor 20, the light emitted from the first light irradiating portion 22A, including the reflected light of the first reflecting portion 23A (i.e., the direct light along the optical path L1), is incident onto the surface to be read of the document 2 placed on the object placement table 5, i.e., a desired face of the document 2 (i.e., lower surface of the document 2 in FIG. 2). On the other hand, the light emitted from the second light irradiating portion 22B, including the reflected light of the second reflecting portion 23B, is reflected by the planar reflection mirror 40, and the reflected light (i.e., the indirect light along the optical path L2) is incident onto the desired surface of the document 2 placed on the object placement table 5. Therefore, the direct light irradiation region is formed on the desired surface of the document 2 by the light from the first light irradiating section 22A and the indirect light irradiation region is formed on the same surface of the document 2 by the reflected light from the planar reflection mirror 40. The direct light irradiation region and the indirect light irradiation region partly overlaps (are partly superimposed) to form the belt-like irradiation region extending in the main scanning direction. Because the document 2, which is the object to be read, is irradiated with the light from the two directions, the characters and image information on the document 2 can be accurately read even if the object to be read is not two-dimensional but three-dimensional.

The planar reflection mirror 40 of the linear light source apparatus 10 for the image reader has the auxiliary reflecting surface portions. Therefore, even if the reflection light of the light emitting element facing portions 28 and 28 is emitted from the second light irradiating portion 22B and includes the light directed outward of the longitudinal ends of the planar reflecting surface 41 (the light along the optical path L4 in FIG. 5), it is possible to cause the light to be incident onto (enter) the planar reflecting surface 41. Accordingly, it is possible to effectively use the light from the light emitting elements 12 and 12.

The present invention is not limited to the above-described embodiments, and various changes and modifications may be made to the above-mentioned embodiments. For example, the light emitting element facing portions of the linear light emitting unit 11 may not be directly irradiated with the light from the light emitting elements and/or the concave reflection mirrors, but may be irradiated with the light that has transmitted the light conductor 20.

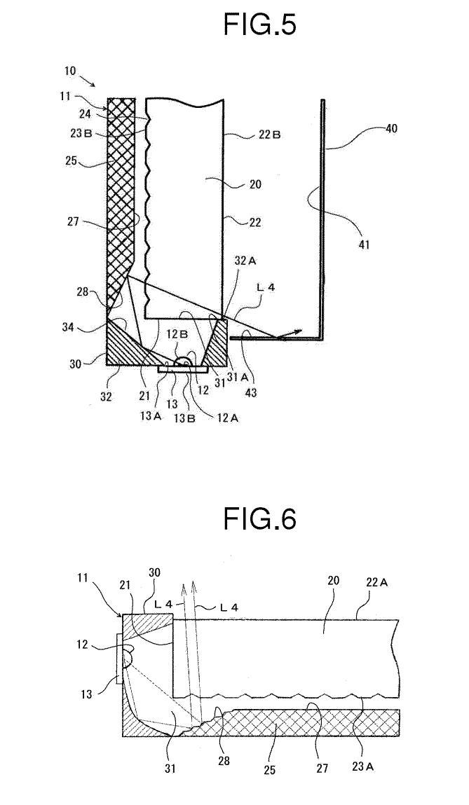

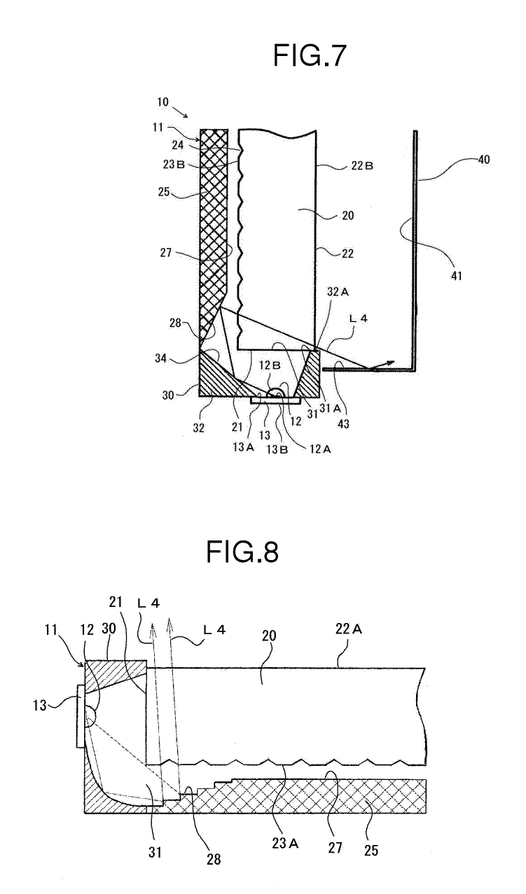

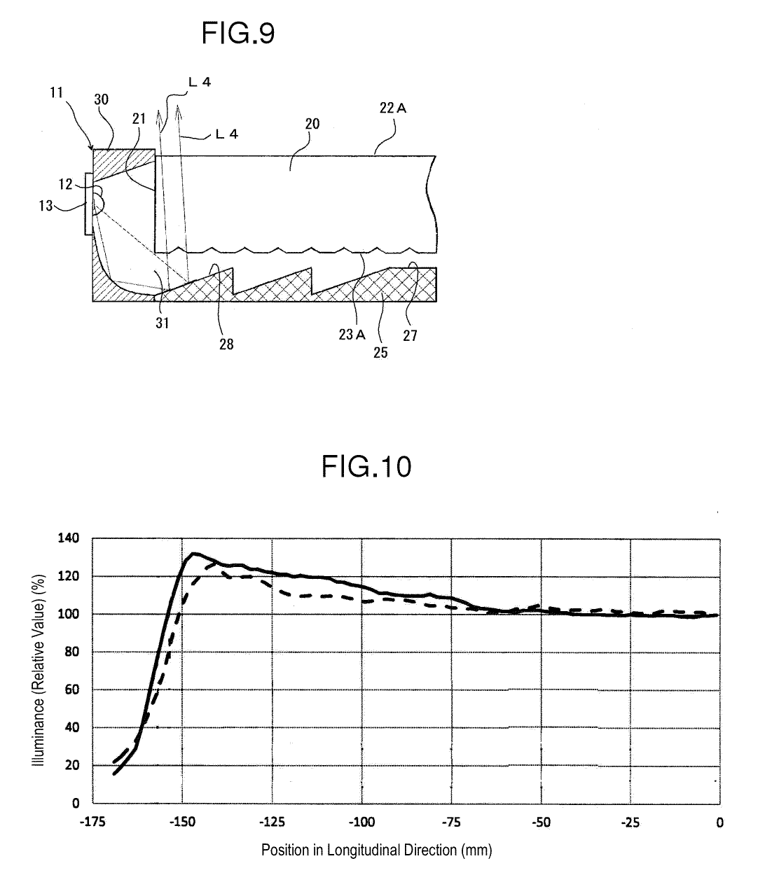

The configuration of the light emitting element facing portions 28 is not limited to the configuration illustrated in FIGS. 3 to 5 as long as the light emitting element facing portions 28 are able to be irradiated with the light from the light emitting elements and/or the concave reflection mirrors and reflect the light incident onto the light emitting element facing portions 28 toward the adjacent end faces of the light conductor 20 so that the light is introduced into the light conductor 20. Specifically, each of the light emitting element facing portions 28 may be configured as shown in any one of FIGS. 6 to 9. The light emitting element facing portion 28 shown in FIG. 6 includes a convexo-concave surface that is inclined from the inside to the outside in the direction apart from the light conductor 20. The light emitting element facing portion 28 shown in FIGS. 7 and 8 is a stepwise (stairway-like) portion inclined from the inside to the outside in the direction apart from the light conductor 20. The light emitting element facing portion 28 shown in FIG. 9 is the sawtooth-like (serration) portion. The linear light emitting units 11 shown in FIGS. 6 to 8 have a configuration similar to the linear light emitting unit 11 shown in FIGS. 1 to 5 except for the structure of the light emitting element facing portions 28 and the shape of the concave reflecting surfaces 34 of the concave reflection mirrors 30. The linear light emitting units 11 shown in FIG. 9 has a different structure for the light emitting element facing portions 28 and a different shape for the concave reflecting surfaces 34 of the concave reflection mirrors 30. In addition, the light emitting element facing portions 28 are directly irradiated with (directly receive) the light from the light emitting elements 12 and/or the concave reflection mirrors 30 and also irradiated with the light that has transmitted the light conductor 20. With respect to other components, the linear light emitting unit 11 shown in FIG. 9 has a configuration similar to the linear light emitting unit 11 shown in FIGS. 1 to 5.

It should be noted that the planar reflection mirrors 40 may not have the auxiliary reflecting surface portions. It should also be noted that the linear light source apparatus 10 for the image reader may not have the planar reflection mirror.

Now, experimental examples to confirm the function and advantages of the linear light source apparatus 10 of the present embodiment will be described.

### Experimental Example I

It should be noted that in the following experimental example and comparative example description, reference numerals are denoted for referential purpose only for the better understanding of the present embodiment and not intended to limit the scope of the present invention. A linear light source apparatus for an image reader that included a linear light emitting unit 11 and a planar reflection mirror 40 in accordance with the configuration shown in FIGS. 1 to 5 was prepared. This linear light source apparatus may be referred to as “an experimental linear light source apparatus.” The experimental linear light source apparatus was placed below an object placement table 5, which was a rectangular flat glass plate having a thickness of 3 mm.

In the experimental linear light source apparatus, the light conductor 20 of the linear light emitting unit 11 was made from the acrylic resin. The light conductor 20 had a generally cylindrical shape, with the total length being 320 mm and the diameter being 5 mm. The light conductor support member 25 was made from a white resin, which was prepared by whitening a polycarbonate resin. The length of the light conductor facing surface 27 in the longitudinal direction was 320 mm. The light emitting element facing portion 28 of the light conductor facing surface 27 was formed by a flat and smooth tapered surface inclined from the inside to the outside in a direction apart from the light conductor 20. The light emitting element facing portion 28 was spanned 10 mm from the longitudinal end of the light conductor facing surface 27. The distance between the light emitting element facing portion 28 and the light conductor 20 was 0.6 mm at maximum and 0.2 mm at minimum. The distance between the light conductor facing surface 27, excluding the light emitting element facing portion 28, and the light conductor 20 was 0.2 mm and constant.

The concave reflection mirror 30 had a concave reflecting surface 34 which was shaped like a generally truncated cone. The light projecting opening 31 of the base member 32, which was one opening (first opening) of the base member 32 having a generally circular shape, had a maximum diameter of 6.2 mm and a minimum diameter of 4.8 mm. The other circular opening (second opening) of the base member 32 had a diameter of 3.3 mm. The maximum width of the end face 32A at the first opening of the light projecting opening 31 was 1.6 mm.

The linear light emitting unit 11 was arranged such that the distance from the center axis of the light conductor 20 to the object reading axis Y in the horizontal direction (auxiliary scanning direction) was 6.2 mm, and the distance from the center axis of the light conductor 20 to the object placement table surface 5A in the perpendicular direction was 12 mm.

The planar reflection mirror 40 had a main reflecting surface portion, which defined the rectangular planar reflecting plane 41 with the size of 320 mm (length)×10 mm (width), and auxiliary reflecting surface portions, which defined parallelogram planar reflecting planes 43 with the size of 11 mm (length)×10 mm (width). The planar reflection mirror 40 was arranged such that the distance from the center axis of the light conductor 20 to the planar reflecting plane 41 in the horizontal direction (auxiliary scanning direction) was 14.2 mm. The planar reflection mirror 40 was fixedly supported by the reflection mirror support member 44 such that the inclined angle of the planar reflection mirror 40 relative to the document table surface 5A of the object placement table 5 was 60 degrees.

That position on the object placement table surface 5A of the object placement table 5, which was 12 mm apart from the center axis of the light conductor 20 in the vertical direction, was irradiated with the light from the experimental linear light source apparatus, and the illuminance distribution in the longitudinal direction of the light conductor 20 was measured. The measurement result was indicated by the solid line in FIG. 10. In FIG. 10, the illuminance of an area corresponding to the center area of the light conductor 20 in the longitudinal direction was used as the reference value (100%), and the illuminance distribution of the experimental linear light source apparatus was expressed by the relative values of illuminance with respect to the reference value.

The effective light emitting length (the length of the area having the relative illuminance value equal to or more than 80%) was measured based on the illuminance distribution shown in FIG. 10. It was then confirmed that the effective light emitting length was 314 mm.

### Comparative Example I

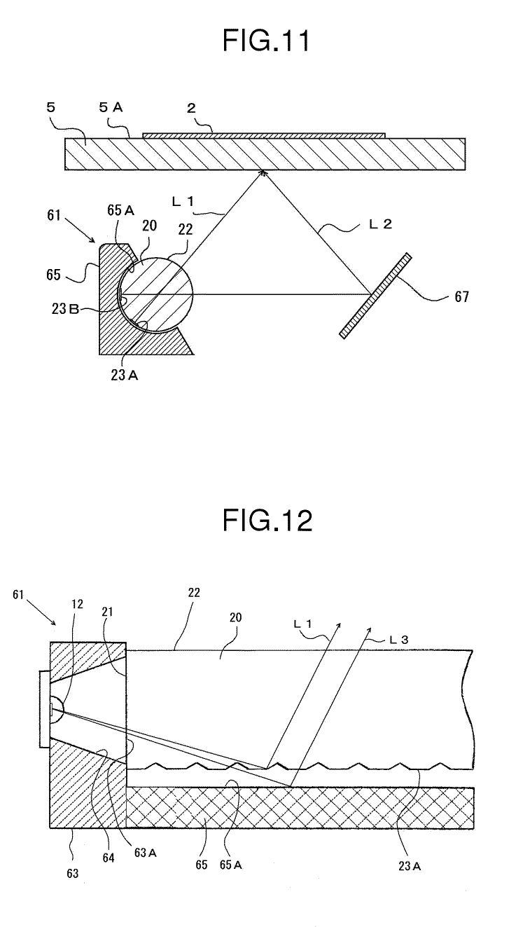

Another linear light source apparatus for an image reader was prepared in accordance with the configuration shown in FIGS. 11 and 12 such that the linear light emitting unit 61 was provided instead of the linear light emitting unit 11 and the planar reflection mirror 67 was provided instead of the planar reflection mirror 40. This linear light source apparatus was referred to as “experimental linear light source apparatus for comparison” or “comparative experimental linear light source apparatus.” With regard to other components of the comparative experimental linear light source apparatus, the comparative experimental linear light source apparatus was similar to the experimental linear light source apparatus of Experimental Example I.

The linear light emitting unit 61 of the comparative experimental linear light source apparatus did not have the light emitting element facing portion 28 on the diffusing-and-reflecting plane 65A of the light conductor support member 65. In addition, the concave reflection mirror 63 had a circular light projecting opening 63A having a diameter of 3.3 mm, which was slightly smaller than the end face 21 of the light conductor 20. The light projecting opening 63A was closed by the end face 21 of the light conductor 20. Other components and structures of the linear light emitting unit 61 were similar to the experimental linear light emitting unit 11 of the linear light source apparatus of Experimental Example I.

The illuminance distribution of the comparative experimental linear light source apparatus, in the longitudinal direction of the light conductor was measured in the same manner as Experimental Example I. The measurement result was indicated by the broken line in FIG. 10. In FIG. 10, the illuminance of an area corresponding to the center area of the light conductor 20 in the longitudinal direction was used as the reference value (100%), and the illuminance distribution of the comparative experimental linear light source apparatus for comparison was expressed by the relative values of illuminance with respect to the reference value.

The effective light emitting length (the length of the area having the relative illuminance value equal to or more than 80%) was measured based on the illuminance distribution shown in FIG. 10. It was then confirmed that the effective light emitting length was 306 mm.

The above-described results revealed that the experimental linear light source apparatus of Experimental Example I according to the present embodiment had a longer effective light emitting length than the comparative experimental linear light source apparatus of Comparative Example I, and that the effective light emitting length of the experimental linear light source apparatus of Experimental Example I was substantially the same as the length of the light conductor 20.

It was therefore confirmed that the linear light source apparatus for the image reader according to the present embodiment could provide an effective light emitting length that was substantially the same as the length of the light conductor.

While certain embodiments have been described, these embodiments have been presented by way of example only, and are not intended to limit the scope of the present invention. The novel apparatuses (devices) and methods thereof described herein may be embodied in a variety of other forms. Furthermore, various omissions, substitutions, modifications and changes in the form of the apparatuses (devices) and methods thereof described herein may be made without departing from the gist of the present invention. The accompanying claims and their equivalents are intended to cover such forms of modifications as would fall within the scope and gist of the present invention.

The present application is based upon and claims the benefit of a priority from Japanese Patent Application No. 2013-112939, filed May 29, 2013, and the entire content of this Japanese Patent Application is incorporated herein by reference.

What is claimed is:

1. A linear light source apparatus for an image reader, the light source apparatus comprising:
a rod-shaped light conductor, the light conductor comprises a reflecting portion extending in a longitudinal direction of the light conductor on an outer circumferential surface of the light conductor;
a light emitting element arranged to face an end face of the light conductor;
a concave reflection mirror that surrounds the light emitting element;
a diffusing-and-reflecting member that comprises a diffusing-and-reflecting plane disposed to face the reflecting portion along the longitudinal direction of the light conductor; and
a light emitting element facing portion that faces the light emitting element, the facing portion being provided at an end of the diffusing-and-reflecting plane of the diffusing-and-reflecting member in a vicinity of the light emitting element, a light from the light emitting element, the concave reflection mirror, or the light emitting element and the concave reflection mirror is incident on the light emitting element facing portion, the light incident on the light emitting element facing portion being reflected toward the end face of the light conductor in the vicinity of the light emitting element facing portion, and introduced into the light conductor.

2. The linear light source apparatus for the image reader according to claim 1, wherein a light projecting opening of the concave reflection mirror is provided to be exposed to the end face of the light conductor and the light emitting element facing portion.

3. The linear light source apparatus for the image reader according to claim 1 further comprising a reflection mirror that faces the light conductor along the longitudinal direction of the light conductor, wherein
the reflecting portion of the light conductor includes a first reflecting portion and a second reflecting portion, the first and second reflecting portions extend in the longitudinal direction of the light conductor and are spaced from each other,
a first light irradiating section is formed in a first region opposite the first reflecting portion on the outer circumferential surface of the light conductor, a second light irradiating section is formed in a second region opposite the second reflecting portion on the outer circumferential surface of the light conductor,
a first light from the first reflecting portion is emitted toward an object placement surface, on which an object to be read is configured to be placed, from the first light irradiating section, and a second light from the second reflecting portion is emitted toward the reflection mirror from the second light irradiating section, such that the second light from the reflection mirror and the first light from the first reflecting portion are superimposed each other on the object placement surface.

4. The linear light source apparatus for the image reader according to claim 3, wherein the reflection mirror has a main reflection plane that faces the light conductor and the object placement surface, and an auxiliary reflection plane that reflects light directed outward of the longitudinal end of the light conductor from the main reflection plane, toward the main reflection plane.

5. A linear light source apparatus for an image reader, the light source apparatus comprising:
a rod-shaped light conductor that comprises a reflecting portion extending in a longitudinal direction of the light conductor on an outer circumferential surface of the light conductor;
a plurality of light emitting elements arranged to face opposite end faces of the light conductor, respectively;
a plurality of concave reflection mirrors that surrounds the plurality of light emitting elements, respectively;
a diffusing-and-reflecting member that comprises a diffusing-and-reflecting plane that faces the reflecting portion along the longitudinal direction of the light conductor; and
a plurality of light emitting element facing portions that faces the plurality of light emitting elements respectively, the plurality of light emitting element facing portions being provided at opposite ends of the diffusing-and-reflecting plane of the diffusing-and-reflecting member in the vicinity of the light emitting elements, respectively,
a light from the light emitting elements, the concave reflection mirrors, or the light emitting elements and the concave reflection mirrors, being incident on the light emitting element facing portions, the light incident on the light emitting element facing portions being reflected toward the end faces of the light conductor in the vicinity of the light emitting element facing portions, respectively, and introduced into the light conductor.

6. The linear light source apparatus for the image reader according to claim 5, wherein a light projecting opening of each of the concave reflection mirrors is provided to be exposed to the associated end face of the light conductor and the associated light emitting element facing portion.

7. The linear light source apparatus for the image reader according to claim 5 further comprising a reflection mirror that faces the light conductor along the longitudinal direction of the light conductor, wherein
the reflecting portion of the light conductor includes a first reflecting portion and a second reflecting portion, the first and second reflecting portions extend in the longitudinal direction of the light conductor and are spaced from each other,
a first light irradiating section is formed in a first region opposite the first reflecting portion on the outer circumferential surface of the light conductor, a second light irradiating section is formed in a second region opposite the second reflecting portion on the outer circumferential surface of the light conductor,
a first light from the first reflecting portion is emitted toward an object placement surface, on which an object to be read is configured to be placed, from the first light irradiating section, and a second light from the second reflecting portion is emitted toward the reflection mirror from the second light irradiating section, such that the first light from the reflection mirror and the second light from the first reflecting portion are superimposed each other on the object placement surface.

8. The linear light source apparatus for the image reader according to claim 7, wherein the reflection mirror comprises a main reflection plane that faces the light conductor and the object placement surface, and auxiliary reflection planes that reflect light directed outward of the opposite longitudinal ends of the light conductor from the main reflection plane, toward the main reflection plane.
